(19) United States
(12) Patent Application Publication
(10) Pub. No.: US 2011/0231890 A1
(43) Pub. Date: Sep. 22, 2011

(54) Systems and Methods for Managing Internet Access

(76) Inventor: Tom C. Tovar, San Francisco, CA (US)

(21) Appl. No.: 12/896,821

(22) Filed: Oct. 1, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00

(52) U.S. Cl. 726/1

(57) ABSTRACT

Various embodiments of the present invention include methods and systems for managing Internet access. An exemplary method for managing Internet access includes three steps. First a request is received to access the Internet. Second, a determination is made whether the request is being made during a restricted time period. Third, Internet access is selectively managed Internet access for an end user via a computing device, by blocking Internet access if the determination is that the request was made during a restricted time period or granting Internet access if the determination is that the request was made outside the restricted time period.

### CROSS REFERENCES TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention is directed to systems and methods for selectively managing Internet access.

### SUMMARY OF THE INVENTION

Various embodiments of the invention comprise methods and systems for managing Internet access. According to various embodiments, an exemplary method for managing Internet access includes at least three steps. First, a request is received to access the Internet by an end user via a user device coupled to an Internet service. Second, a determination is made whether the request is being made during a restricted time period. The restricted time period may already have been established by an initiating end user's input to a restriction policy application via a user interface between the initiating end user and an Internet service. Third, the end user's Internet access is selectively managed by blocking Internet access if the determination is that the request was made during a restricted time period or granting Internet access if the determination is that the request was made outside the restricted time period.

In further embodiments, a system for managing Internet access is provided. The system may include a user device configured for displaying user interface, an Internet service and a processor. The user interface may be between an end user and an Internet service, and it may be configured to receive a request to access the Internet by an end user. The Internet service may apply different restricted time periods for different end user devices. The Internet service may be for determining whether the request is being made during a restricted time period, the restricted time period having been established by an initiating end user's input to a restriction policy application via a user interface between the initiating end user and the Internet service. The processor is for executing the instructions stored in memory to selectively manage Internet access for the end user via the user device, by blocking Internet access if the determination is that the request was made during a restricted time period or granting Internet access if the determination is that the request was made outside the restricted time period.

In yet further embodiments of the present technology, a non-transitory computer-readable storage medium having embodied thereon a program is given. The program is executable by a processor in a computing device to perform one or more methods for managing Internet access, such as those exemplary methods for managing Internet access as described herein.

### BRIEF DESCRIPTION OF THE DRAWINGS

FIG. 1 is a flow diagram of an exemplary method for managing Internet access, according to various embodiments of the invention.

FIG. 2 is a block diagram of an exemplary environment for managing Internet access in accordance with various embodiments of the present invention.

FIG. 3 is a screen shot showing a description of a restriction policy application, according to various embodiments of the invention.

FIG. 4A is screen shot of a terminal web page for establishing restriction criteria for a restriction policy application, according to various embodiments of the invention.

FIG. 4B is screen shot of a web page for informing an end user that their request to access the Internet was denied, according to various embodiments of the invention.

FIG. 5 is a block diagram of a DNS server arrangement in accordance with various embodiments of the present invention.

FIG. 6 is a block diagram of an exemplary system for providing variable content control for Internet users in accordance with various embodiments of the present invention.

FIG. 7 is a block diagram of an exemplary system for providing notifications regarding Internet access in accordance with various embodiments of the present invention.

### DETAILED DESCRIPTION

Various embodiments of the present invention include methods and systems for managing Internet access. According to various embodiments of the invention, a restriction policy application accepts restriction criteria. Restriction criteria may include but is not limited to establishing a restricted time period for when Internet access is not allowed to end users. Restriction criteria may be any criteria that define when access to the Internet for one or more end users is blocked by an Internet service and/or a DNS server. For instance, if an end user attempts to access the Internet during a restricted time period, then the end user's attempt is blocked and a message may appear on the user device indicating that the end user's request to access the Internet at this time has been denied. As used throughout, end users are those users that may access the Internet utilizing an Internet service and/or a DNS server. An initiating end user is a type of end user who can establish restriction criteria for a restricted policy application. In some embodiments, an initiating user can establish end user device specific restriction criteria.

Generally speaking, an administrator may create and enforce mediation polices for one or more end users that utilize computing devices coupled to an Internet service delivered to a location such as a home, residence place of business or campus. The term “administrator” may include not only individuals, such as parents, but also any individual creating mediation policies regarding the Internet service delivered to end users. It will be understood that an administrator may also be an end user, although end users who are not also administrators may not create or apply mediation policies.

It will be further understood that because of the diversity of computing devices that may connect to the Internet service, the mediation policy may be applied to the Internet service rather than requiring the mediation policy to affect each computing device individually, such as a mediation application resident on each computing device. In various exemplary embodiments a value-based mediation policy may also reside as a stand alone application on one or more of the computing devices.

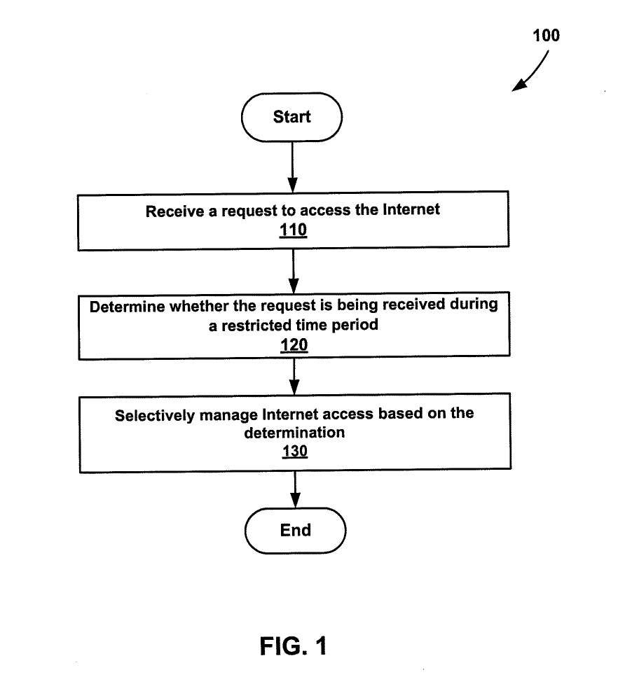

Referring to FIG. 1, a method 100 for managing Internet access provided to one or more end users begins with a step 110 of receiving a request to access the Internet from an end user via a user device. An end user may launch a web browser and/or supply input via the user interface displayed on the user device. For example, the user interface may display a variety of input fields to the end user, such as a text box to enter an Internet search, a web page address, a URL, a request to access a game server and the like. According to various embodiments, receiving the request to access the Internet from at least one end user may be performed by a DNS server and/or an Internet service via a user interface that appears on the user device.

At step 120, a determination is made whether the request is being made during a restricted time period. The restricted time period may have been established by an initiating end user's input to a restriction policy application via a user interface between the initiating end user and the Internet service. The restricted time period may include a morning, afternoon, evening, late night and any combination thereof. The restricted time period may include a start time and an end time. The restricted time period may include one or more days.

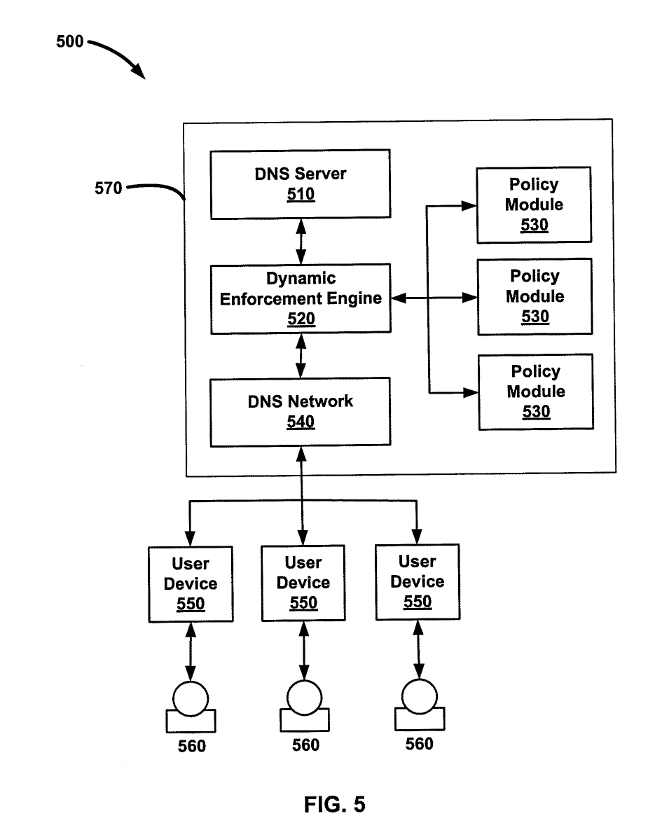

In some embodiments, an initiating end user 160 may launch the restriction policy application. The restriction policy application may be a program resident on the user device 550 (FIG. 5.), or may be resident on a computer or network apart from the user device 550. The restriction policy application may prompt the initiating end user 560 (FIG. 5) for a username and password (or other similar identifying information) to confirm the identity of the authorized initiating end user 560. Upon successful entry of the identifying information, the authorized initiating end user 560 is prompted to select the desired restriction criteria.

In some embodiments, the restriction criteria include one or more actual times of a given day. The restriction criteria entered by the initiating end user 560 (FIG. 5) may comprise a start time and end time; a general period of the day (such as morning, afternoon, evening, and late night); one or more days of the week, and any combinations thereof. Embodiments may include the initiating end user's ability to enter multiple entries in a monitoring list to define or otherwise establish restricted time periods for the restriction policy application. For example, the initiating end user 560 (FIG. 5) may enter more than one set of start times and end times, or more than one day of the week. The initiating end user 560 (FIG. 5) may enable one or more of the restriction criteria, and then activate the restriction policy application.

According to various embodiments, the restriction policy application may be used by a parent (who may be considered an initiating end user in this example) to grant or allow Internet access to his or her child (who may be considered an end user). Thus, various embodiments of the restriction policy application may be used to restrict Internet access for children at night. For example, a child's bedtime may be 9:00 pm. The restriction criteria may be set for a start time of 9:00 pm and an end time of 7:00 am. Thus, during the period 9:00 pm to 7:00 am, the restriction policy application would deny access to the Internet. This would prevent the child from logging onto the Internet between 9:00 pm to 7:00 am.

According to various embodiments of the present invention, the restricted time period may be provided by a monitoring list generated by the Internet service or third parties. In further embodiments, the restricted time period may be provided by a monitoring list created by the initiating end user or socially produced by groups of users of the Internet service.

Still referring to FIG. 1, at step 130, the end user's Internet access is selectively managed via a computing device. Internet access is blocked if the determination is that the request for Internet access was made during a restricted time period. Internet access is granted if the determination is that the request for Internet access was made outside the restricted time period. In some embodiments, selectively managing Internet access further includes comparing the request to the restriction criteria established by the initiating end user in the restriction policy application and blocking a resolution performed by the Internet service if the request does not meet the restriction criteria.

Blocking the Internet access may comprise redirecting, blocking, or substituting a request to access Internet content specified in the request to a different Internet content, such as the initial provisioning page providing access to the Internet service. According to various embodiments, blocking the Internet access may comprise displaying a message on the user device notifying the end user that their attempt to access the Internet has been denied. According to various embodiments of the present technology, selectively managing Internet access may further comprise comparing the request to the restriction criteria established by the initiating end user in the restriction policy application and allowing a resolution performed by Internet service provider if the request meets the restriction criteria.

Optional steps for the method 100 may include overriding the restriction policy application by the end user selecting an override button provided on the user interface. Also, the restricted time period may be modified or otherwise altered by the initiating end user selectively editing the restricted time period via the user interface associated with the restriction policy application. Also, the initiating end user may select different time periods for different end users and/or different end user devices. Policies of the restriction policy application may be applied to the Internet service. In various embodiments, applying the policies of the restriction policy application may comprise dynamically logging and reporting attempted Internet access by end users.

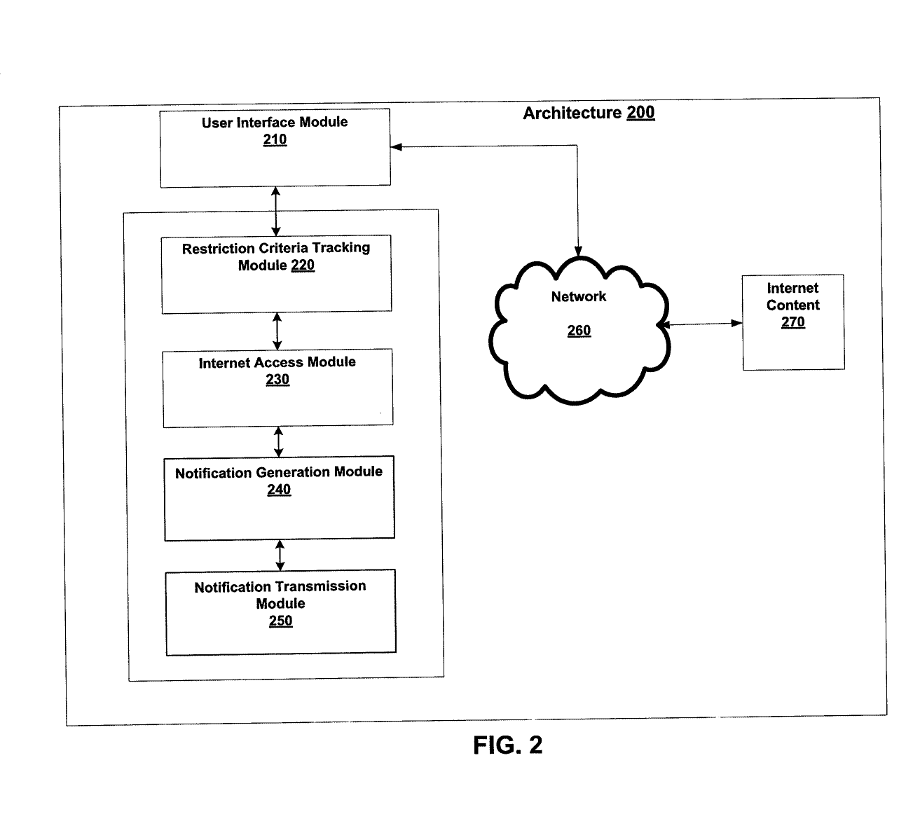

FIG. 2 illustrates an exemplary architecture 200 of an exemplary system for a restriction policy application. The architecture 200 includes a user interface module 210, a restriction criteria tracking module 220, an Internet access module 230, a notification generation module 240, a notification transmission module 250, a network 260, and an Internet content 270. Alternative embodiments may comprise more, less, or functionally equivalent modules.

It will be appreciated by one of ordinary skill that examples of non-transitory computer readable storage media may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

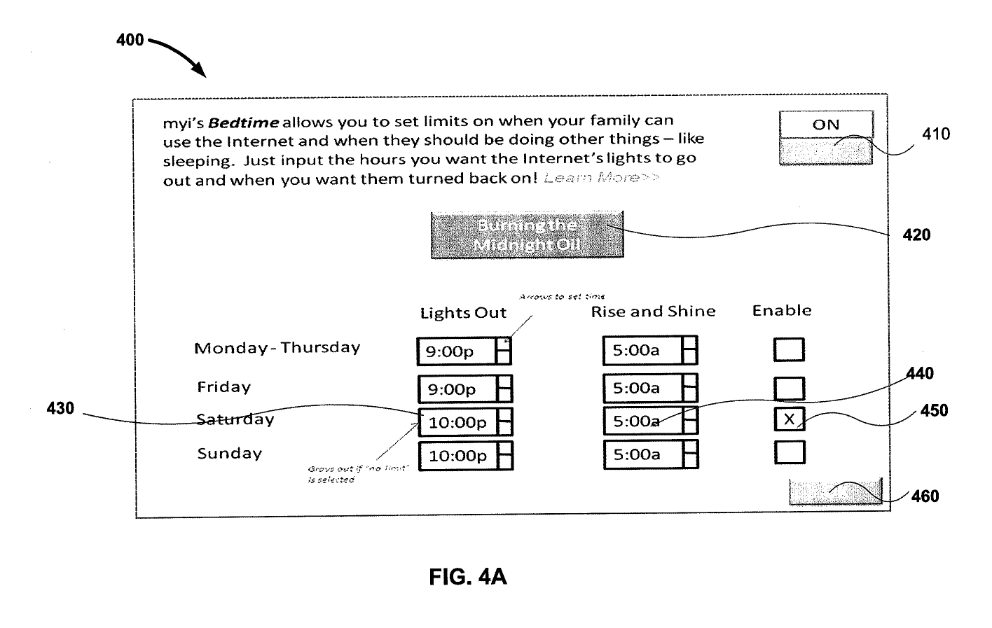

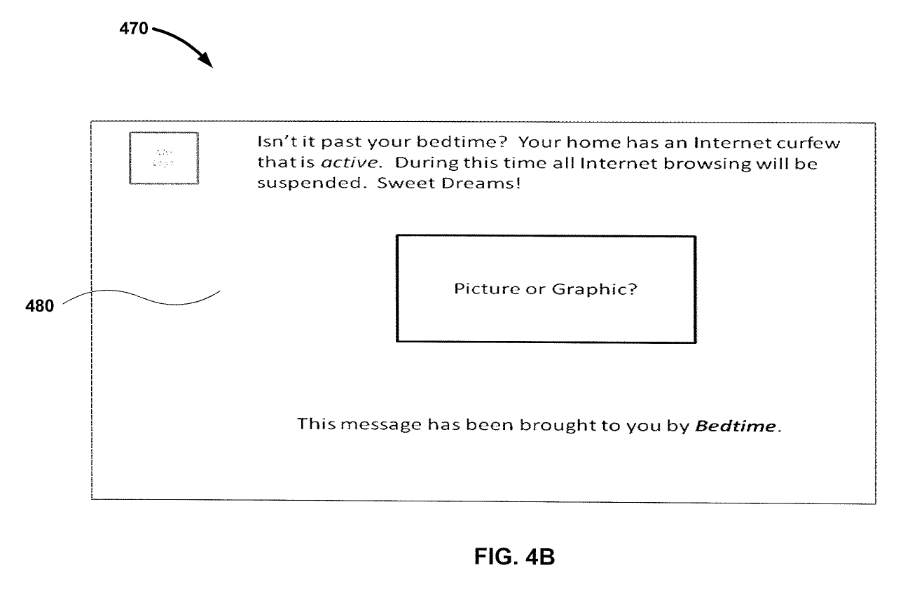

The user interface module 210 provides one or more user interfaces to the end user as a result of the restriction policy application. The user interface module 210 provides, for instance, a user interface between the end user and the Internet service, so that communications between the two are enabled. Exemplary user interfaces provided by the user interface module 210 are shown in FIGS. 4A and 4B.

The restriction criteria tracking module 220 may perform a step of receiving and/or tracking information related to restriction criteria established by an initiating end user. As described in conjunction with step 120 of the method 100 and FIG. 1, the initiating end user may establish restriction criteria (such as a restricted time period) for the restriction policy application. The restriction criteria may provide data as to when Internet access should be allowed or blocked for one or more end users.

The Internet access module 230 may perform a step of determining whether an end user has attempted to access the Internet during a restricted time period (such as the step 120 of the method 100 described earlier herein in relation to FIG. 1). The optional notification generation module 240 may perform a step of generating a notification for the initiating end user that an attempt to access the Internet was made by one or more end users during a restricted time period. The optional notification transmission module 250 may perform a step of transmitting the notification to the initiating end user in one or more formats (such as a text message, a multimedia message, an email, an instant message, a phone call, a fax, a data transmission, an audio transmission, a video transmission, and/or any combination thereof). Note that modules 220, 230, 240, and 250 may be considered to constitute an Internet mediation system. After provisioning the Internet service the Internet mediation system may communicate directly with the network 260.

The architecture 200 includes a network 260 which may comprise a DNS server. The network 260 may also include any type and number of databases, servers, end users, computing devices, and policy engines. It will be appreciated by one skilled in the art that the system in FIG. 2 may be merged with or used in conjunction with any of the other exemplary systems described herein, including but not limited to the systems shown in FIGS. 5, 6, and 7. Furthermore, any of the optional steps described in method 100 of FIG. 1 may be performed by or in conjunction with one or more modules depicted in FIG. 2.

One or more of the modules described above may be used to gather and record data relative to Internet content accessed and attempts to access Internet content. Data collected may include addresses accessed and attempted to be accessed, number of times visited, duration of visit, whether other links are accessed from the site, etc. The data may be used to “learn” the search patterns of one or more users of the system. The system may then modify the mediation policy according to the learned history of use.

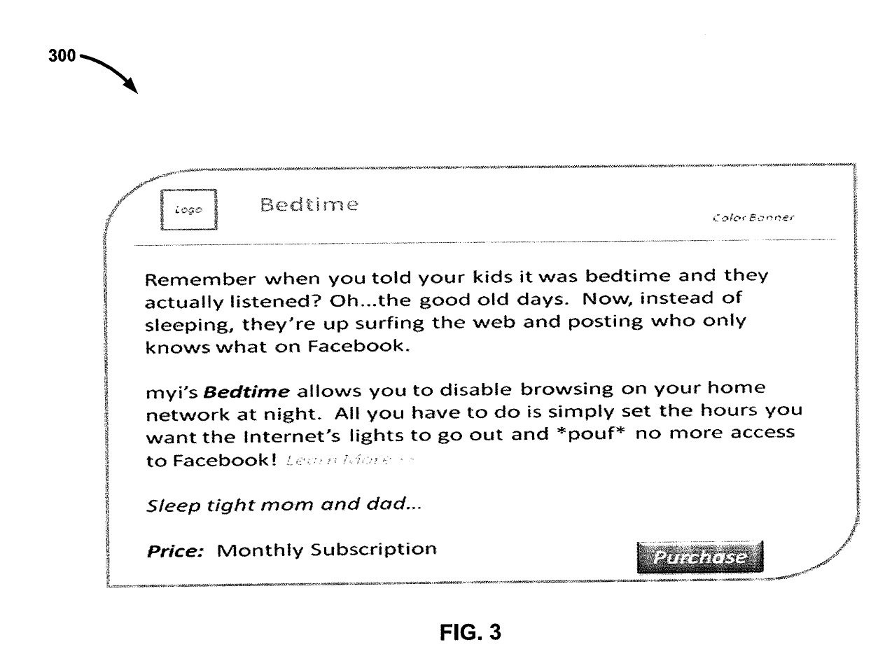

FIG. 3 is an exemplary screenshot of a user interface 300 that may be presented to an end user. The exemplary screenshot 300 provides a written summary or description of a restriction policy application. Such a restriction policy application may be used to implement one or more methods described herein. The end user may click or otherwise actuate a “Learn More” link which will provide more information about the restriction policy application beyond the initial summary provided to the end user. The end user may purchase access to the notification policy application by clicking or otherwise actuating the “Purchase” button. Following the purchase of the restriction policy application, the end user may be provided an opportunity to download the restriction policy application onto their user device.

FIG. 4A is an exemplary screenshot of a user interface 400 for managing Internet access. The user interface 400 may be displayed to an initiating end user as part of a restriction policy application. The user interface 400 may comprise a configuration drawer. According to various embodiments, a first end user (such as an initiating end user) may utilize the user interface 400 to set configurations of the restriction policy application. An optional summary of the restriction policy application may be provided in the exemplary user interface 400. As shown in FIG. 4A, the user interface 400 may include an On/Off button set 410, an override 420, one or more restricted start time fields 430 (which may be labeled as “Lights Out” fields), one or more restricted end time fields 440 (which may be labeled as “Rise and Shine” fields) and one or more activation buttons 450 (which may be labeled as “Enable” buttons). The user interface 400 may also include an OK button 460. When clicked, pressed or otherwise actuated, the override button 420 (which is labeled as “Burning the Midnight Oil in the exemplary user interface 400) will override any existing restriction criteria already established in the restriction policy application.

A listing of the restricted start time fields 430 (which may be labeled as “Lights Out” fields), one or more restricted end time fields 440 (which may be labeled as “Rise and Shine” fields) and one or more activation buttons 450 may be provided in a monitoring list to the end user. A restricted start time field 430 may be associated with a restricted end time field 440 and an activation button 450. For instance, as depicted in FIG. 4, the restricted start time field 430, the restricted end time field 440 and the activation button 450 listed across in a given row may be associated with one another. Optionally, a given restricted start time field 430, a restricted end time field 440 and an activation button 450 may be associated with a one or more days. Additional management features that restrict time based on individual end users or end user devices may also be included. It will be appreciated by those skilled in the art that any number of configurations showing the associations of a restricted start field, a restricted end field and an activation button may be depicted in the user interface 400.

For instance, as shown in FIG. 4A, the rows provide for restricted time periods for Monday-Thursday, Friday, Saturday and Sunday. In the third row, for Saturdays, the restricted time period begins at 10:00 pm (as shown in the restricted time start field labeled 430), the restricted time period ends at 5:00 am (as depicted in the restricted time end field labeled 440, and this restricted time period designation for Saturdays has been activated (as shown with the checked activation button 450). While this setting is activated, for every Saturday, all Internet access for end users is blocked by the restriction policy from 10:00 pm to 5:00 am during the restricted time period.

The one or more restricted time start fields 430 are fields by which an initiating end user may enter information as to when the restricted time period begins or is active for a given day or selected days. In other words, the one or more restricted time start fields 430 allow for an initiating end user to input when the restriction policy may restrict or block end users from accessing the Internet. The one or more restricted time end fields 440 are fields by which an initiating end user may enter information as to when the restricted time period ends or ceases for a given day or selected days. In other words, the one or more restricted time end fields 440 allow for an initiating end user to input when the restriction policy may stop restricting or blocking end users from accessing the Internet. In exemplary embodiments of the invention, the initiating end users may input the information for the one or more restricted time start fields 430 and the one or more restricted time end fields 440 by selecting up or down arrows to manipulate the time shown in the fields.

Initiating end users may repeat the process of entering data into the one or more restricted time start fields 420, the one or more restricted time end fields 430 and selecting the one or more activation buttons 450 until all of their selections have been furnished to set the restriction policy application. The selections are shown in the monitoring list provided in the user interface 400. Once all the selections of an initiating end user have been furnished, the initiating end user may click on or otherwise actuate the OK button 460 to have their restriction settings saved and stored for future use. Once the OK button 460 has been selected, the configuration drawer interface 400 appears to close. To activate the functionality of the restriction policy application, an initiating end user may select, click or otherwise actuate the On button of the On/Off button set 410. If an initiating end user inputs their restriction settings but does not enable the restriction policy application by selecting the On button, then an overlay may appear to the initiating end user's device, asking if the initiating end user would like to enable the service prior to closing the configuration drawer. In some embodiments, the default setting for the restriction policy application is “On.” If the initiating end user wishes to disable the functionality of the restriction policy application, the initiating end user may select the Off button of the On/Off button set 410.

FIG. 4B illustrates a screen shot of an exemplary terminal web page 470 that may be displayed when the end user 560 (FIG. 5) tries to access the Internet during a restricted time period. The web page may include a blocking web page having content that includes a message in the form of a text block 480. The text block 480 may include a message that the home has an Internet restricted time period that is active and during this time that all Internet browsing has been suspended. The text block 480 also includes a message that the attempt of the end user to access the Internet was blocked by the mediation system herein described as “Bedtime”.

In this example, a gentle reminder is provided for the end user (such as a child) that they should be in bed, not using the computer. Other examples may include more stern messages, and the messages may vary for successive attempts to access the Internet during a given restriction period (for example, multiple access attempts during a single night). Various embodiments may allow the initiating end user 560 (FIG. 5) to edit the message for each end user on the terminal web page 470.

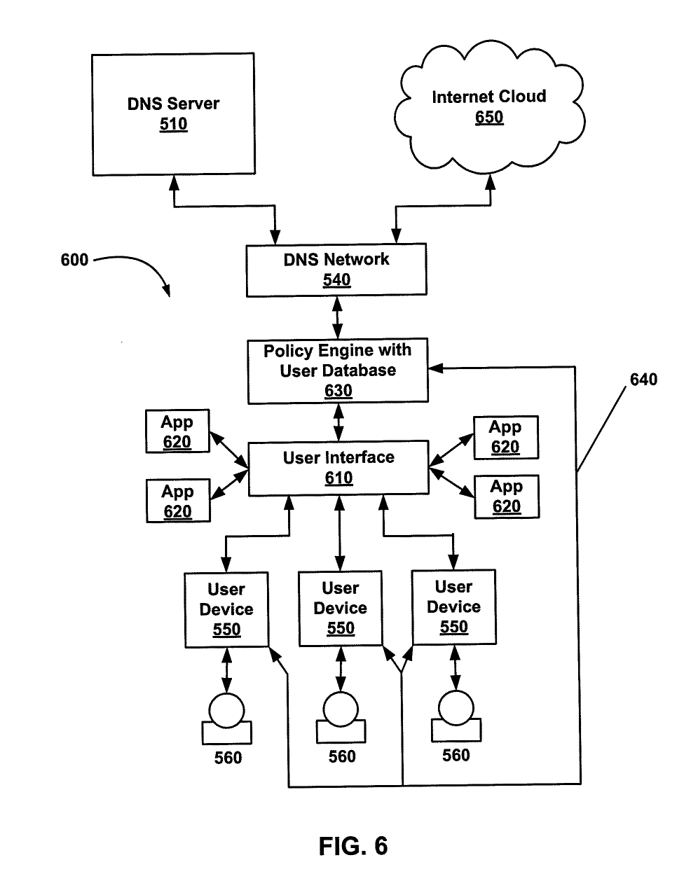

The restriction policy application may restrict the residential computer network (such as 260 in FIG. 2 or 540 in FIGS. 5 and 6) as a whole such that the access to the Internet by any computer coupled to the residential computer network is monitored and/or restricted by the restriction policy application. In various embodiments, the restriction criteria may be applied selectively to one or more computers on the residential computer network. For example, the restriction criteria may be applied only to a user device located in a child's bedroom.

The restriction policy application may have the capability to log attempts to access the Internet during the restricted time periods defined by the restriction criteria. Relevant information such as name of the end user 560 (FIG. 5), if each end user 560 is required to log onto the computer), identifying information relating to the end user's device that was used to attempt access, time of attempted access, and/or the Internet IP address that was blocked or otherwise restricted. The capability to generate reports may also be included with the restriction policy application, as well the ability to generate notifications through email or text messages when access is denied.

The systems and methods described above may typically be resident in an Internet service or a DNS network. The systems and methods described may also be implemented in plug-in utilities, gateway devices, cable modems, proxy servers, set top boxes, and network interface devices.

FIG. 5 illustrates an exemplary Internet service system 500, with a DNS server, that may be utilized to support the above described systems and methods. A DNS server 510 operates in conjunction with a dynamic enforcement engine 520. The dynamic enforcement engine 520 may operate in conjunction with one or more policy modules 530 to establish any applicable polices at the DNS 510 level. The content rules are applied to received user queries, and determine the content that is delivered by the DNS network 540 through various user devices 550 to the end users 560.

The dynamic enforcement engine 520 may generate its policy engine on instructions received from one or more policy modules 530. Each policy module 530 may be constructed to provide various types and levels of services to the DNS network 540. In various embodiments, a policy module 530 may be configured to handle queries directed to subjects including, but not limited to, malicious domain redirection, user access redirection, non-existent domain redirection, and data collection or analysis.

It will be recognized by those skilled in the art that the elements of DNS service 670 may be hosted either locally or remotely. In addition to residing in the DNS service 670, one or more of the DNS network 640, the dynamic enforcement engine 620, and the policy modules 630, and any combination thereof, may be resident on one or more user devices 650.

FIG. 6 shows a schematic layout of an exemplary system 600 for implementing direct and variable end user control. FIG. 6 illustrates that the system 600 may operate installed on a DNS server 510, or with a cloud 650 based installation.

The system 600 utilizes a user interface 610. The user interface 610 may be implemented in many embodiments. One specific implementation of the user interface 610 is as a web page.

The user interface 610 may be accessed by one or more user devices 550 operated by the users 560. The user interface 610 may be accessed though a gateway user device 550 available to the users 560. Suitable user devices 550 include but are not limited to desktops, PCs, laptops, notebooks, gaming devices, tablets, IPods, Smartphones, automobile computer systems, and Internet enabled TVs. The system 600 may also be accessed and controlled remotely through mobile user devices 550, such as a Smartphone or specialized Internet access devices such as a tablet. A Smartphone may be defined as a phone with computing capability. A Smartphone may provide the user 560 with Internet access.

The user interface 610 provides a mechanism for one or more authorized users 560 to establish content policy for the Internet service. The user interface 610 operates between the user devices 550 present in the system 600 and the DNS network 540. Instructions resident on the user interface 610 therefore operate on the Internet service, by controlling at least a portion of DNS resolutions via a dynamic policy engine 630, before the service reaches the displays of the user devices 550.

The user interface 610 provides the users 560 with access to one or more policy applications 620. The user interface 610 may provide access to a selection list to at least one authorized user 560. The authorized user 560 uses the selection list or some other menu mechanism to select those policy applications 620 that the user 560 chooses to apply to the system 600. The authorized user 560 may select any number of the available policy applications for use on the system 600 at any given time. In implementations utilizing Smartphones as the user device 550, the policy applications 620 are downloaded to the device 550. The device 550 then serves as the user interface 610 to communicate directly with the dynamic policy engine 630.

The policy applications 620 may prohibit access to specific sites. The policy applications 620 may also limit the time of day when users or selected users 560 may access certain sites. The policy applications 620 may also manage and analyze duration of access to various sites. It is important to note that the policy applications 620 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service.

The policy applications 620 may provide notifications or alerts to one or more users 560 when sites are accessed. The policy applications 620 may also provide notification of frequency and duration of access of designated sites. The policy applications 620 may also be used to observe, substitute, enable, redirect users, to reward behavior desired from the users by a system administrator, etc. The policy applications 620 may redirect users from a non-favored site to another site. The policy applications 620 may also collect and transmit data characteristic of Internet use.

Access policies supplied by the policy applications 620 may apply to all users 560 of the system 600, or the access policies may be specific to individual users or groups of users 560. The policy applications 620 may be discrete, single purpose applications. Furthermore, exemplary user devices for use with the disclosed systems may have a user interface. In various embodiments, such as those deployed on personal mobile devices, the user interface may be, or may execute, an application, such as a mobile application (hereinafter referred to as a (“app”). An app may be downloaded and installed on a user's mobile device. Users may define the access scheme via a user device, such as through the user interface. Some embodiments of the present invention do not require software to be downloaded or installed locally to the user device and, correspondently, do not require the user to execute a de-install application to cease use of the system.

The policy applications 620 provide the users 550 with a mechanism to take various actions relative to their Internet service feed. The policy applications 620 also allow the users 550 to establish a dynamic policy engine 630 that includes a user database. The policy engine 630 is used to enforce rules associated with each policy application associated with individual end users, not simply block various inappropriate sites from the Internet feed. Rather, the dynamic policy engine 630, controlled by the user interface 610 through user device(s) 550, is used to manage all aspects of the Internet experience for the users 560. In sum, the policy applications 620 may be used to configure the dynamic policy engine 630 to provide the users 560 with a mechanism to personalize the Internet experience. The policy applications 620 may be configured in combinations, and may each be separately configured.

The database in the policy engine 630 may be used to record and to notify users 560 of various data relative to Internet access. The data collected from and provided to the users 560 may include records of access of specific sites, time spent on specific sites, time of day of access, data specific to individual users, etc.

It should also be noted that following an initial setup through the user interface 610 of the policy engine 630, a direct access 640 enforcement loop may be established between the policy engine 630 and the user devices 550. Subsequent accessing of the DNS network 540 utilizing the direct access 640 decreases response time in the system 600, thereby further enhancing the Internet experience of the users 560. Configurations of policy applications 620 that are selected by one or more users 560 designated as system administrators may remain in the user database of the policy engine 630 until such time as it may be modified by the system administrators. The system administrators may define multiple policy configurations, with a combination of policy applications 620, applicable to one or more end users 560 of the system 600. Each policy application 620 may be separately configurable as well. Policy configurations may vary based upon designated times, conditional triggers, or specific requests from the users 560 with administrative authority.

As indicated above, two discrete data flow paths may be established for the system 600. A first data path establishes a set of enforcement policies for the system 600. The first data path flows from at least one user device 550 through the user interface 610, to the policy enforcement engine 630. A second data path 640 may be utilized following the establishment of a set of policies for the system 600. The second data path 640 flows directly between the user device(s) 550 and the policy engine 630. Multiple sets of enforcement policies may be established and saved within the system 600 and implemented selectively by the users 560.

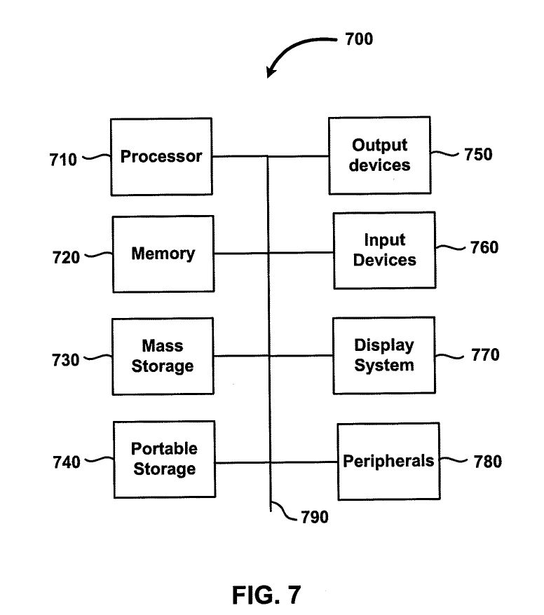

FIG. 7 illustrates an exemplary computing system 700 that may be used to implement an embodiment of the present invention. System 700 of FIG. 7 may be implemented in the context of user devices 550, DNS server 510, Internet cloud 650 and the like. The computing system 700 of FIG. 7 includes one or more processors 710 and memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a graphics display 740, and other peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS resolver. It will be appreciated by those skilled in the art that functionalities and method steps that are performed by a DNS resolver may be performed by an Internet service. One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein. One skilled in the art will further appreciate that the term “Internet content” any content that may be accessed by an Internet access device user device and may comprise one or more of web sites, domains, web pages, web addresses, hyperlinks, URLs, any text, pictures, and/or media (such as video, audio, and any combination of audio and video) provided or displayed on a web page, and any combination thereof.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for managing Internet access, comprising:
receiving a request to access the Internet by an end user via a user device coupled to an Internet service;
making a determination whether the request is being made during a restricted time period, the restricted time period having been established by input of an initiating end user to a restriction policy application via a user interface between the initiating end user and the Internet service; and
selectively managing Internet access for the end user by blocking all Internet access if the determination is that the request was made during a restricted time period or granting Internet access if the determination is that the request was made outside the restricted time period.

2. The method of claim 1, wherein the restriction policy comprises a list of exclusions defined by the initiating end user.

3. The method of claim 1, wherein at least one element of the restriction policy is resident on the DNS server.

4. The method of claim 1, wherein at least one element of the restriction policy is enforced by the DNS server.

5. The method of claim 1, wherein a history of use by at least one user is used by the system to modify a response to a request from the at least one user.

6. The method of claim 1, wherein the restriction policy is applied on a weekly cycle.

7. The method of claim 1, wherein blocking the Internet access comprises redirecting the request to access Internet content to a notification message.

8. The method of claim 1, wherein a customized notification message is used for specific Internet content or Internet sites.

9. The method of claim 1, further comprising directing the end user to a provisioning page when Internet access is blocked.

10. The method of claim 1, wherein blocking the request further comprises displaying a message on the user device.

11. The method of claim 1, wherein the restricted time period is configured by the initiating end user on a daily basis.

12. The method of claim 1, wherein a DNS server initiates a request that is then further processed by the Internet service.

13. The method of claim 1, wherein the restricted time period includes a specific day of the week.

14. The method of claim 1, further including dynamically logging and reporting Internet access of the Internet content provided by the Internet service.

15. The method of claim 1, wherein the restricted time period is provided by an end user with initiating authority.

16. The method of claim 1, wherein the restricted time period is produced by groups of users of the Internet service.

17. The method of claim 1, further comprising overriding the restriction policy application by the end user selecting an override button provided on the user interface.

18. The method of claim 1, further comprising the initiating end user selectively editing the restriction policy via the user interface.

19. The method of claim 1, wherein the restriction policy is configured by the initiating end user for each end user.

20. The method of claim 1, wherein an enforcement period of the restriction policy may be disabled by the initiating end user.

21. The method of claim 1, further comprising the initiating end user modifying the restriction policy relative to individual end users.

22. The method of claim 1, wherein an administrator specifies different mediation policies for different locations.

23. The method of claim 1, wherein an exception list to the restriction policy is maintained by an administrator or the Internet service.

24. The method of claim 1, wherein the restriction policy is modified according to a learned history of Internet access requests.

25. A method for managing Internet access, comprising:
receiving a request to access the Internet by an end user via a user device coupled to a DNS server;
making a determination whether the request is being made during a restricted time period, the restricted time period for each end user having been established by input of an initiating end user to a restriction policy application via a user interface between the initiating end user and the DNS server; and
selectively managing Internet access for each end user using a DNS server to blocking all Internet access if the determination is that the request was made during a restricted time period or granting Internet access if the determination is that the request was made outside the restricted time period.

26. The method of claim 25, wherein blocking the Internet access comprises redirecting a request to access an Internet site by the DNS server to a notification message.

27. The method of claim 25, wherein blocking the request further comprises displaying a message on the user device.

28. The method of claim 25, wherein the restricted time period includes morning, afternoon, evening, late night and any combination thereof.

29. The method of claim 28, wherein the restricted time period includes a start time and an end time.

30. The method of claim 29, wherein the restricted time period includes a day.

31. The method of claim 25, wherein the restricted time period is provided by a monitoring list generated by the DNS server or by third parties.

32. The method of claim 25, wherein the restricted time period is provided by a monitoring list created by the initiating end user or produced by groups of users of the DNS server.

33. The method of claim 25, further comprising overriding the restriction policy application by the end user selecting an override button provided on the user interface.

34. The method of claim 25, further comprising modifying the restricted time period by the initiating end user selectively editing the restricted time period via the user interface.

35. The method of claim 25, further comprising the initiating end user selectively editing the restriction policy via the user interface.

36. The method of claim 25, wherein the restriction policy is configured by the initiating end user for each end user.

37. The method of claim 25, wherein an enforcement period of the restriction policy may be disabled by the initiating end user.

38. The method of claim 25, further comprising the initiating end user modifying the restriction policy relative to individual end users.

39. The method of claim 25, further comprising the initiating end user modifying the restriction policy relative to individual user devices.

40. The method of claim 25, wherein the initiating user receives reports on attempts to access the Internet during restricted times.

41. The method of claim 25, wherein an exception list to the restriction policy is maintained by an administrator or the DNS server.

42. The method of claim 25, wherein the restriction policy is modified according to a learned history of Internet access requests.

43. A system for managing Internet access, the system comprising:
a user device having a user interface between an end user and an Internet service, the user interface configured for receiving a request to access the Internet by the end user;
the Internet service coupled to the user device and configured for making a determination whether the request is being made during a restricted time period, the restricted time period having been established by input of an initiating end user to a restriction policy application via a user interface between the initiating end user and the Internet service; and
a processor for executing the instructions stored in memory to:
selectively manage Internet access for the end user by blocking all Internet access if the determination is that the request was made during a restricted time period or granting Internet access if the determination is that the request was made outside the restricted time period.

44. The system of claim 43, wherein blocking the Internet access comprises redirecting a request to access an IP address specified in the request to a different IP address.

45. The system of claim 43, wherein blocking the Internet access further comprises displaying a message on the user device.

46. The system of claim 43, wherein the restricted time period includes morning, afternoon, evening, late night and any combination thereof.

47. The system of claim 43, wherein the restricted time period includes a start time and an end time.

48. The system of claim 43, wherein the restricted time period includes a day.

49. The system of claim 43, the method further comprising applying policies of the restriction policy application to the Internet service.

50. The system of claim 43, further comprising dynamically logging and reporting Internet access of the Internet content.

51. The system of claim 43, wherein the restricted time period is provided by a monitoring list generated by the Internet service or by third parties.

52. The system of claim 43, wherein the restricted time period is provided by a monitoring list created by the initiating end user or socially produced by groups of users of the Internet service.

53. The system of claim 43, further comprising overriding the restriction policy application by the end user selecting an override button provided on the user interface.

54. The system of claim 43, further comprising modifying the restricted time period by the initiating end user selectively editing the restricted time period via the user interface.

55. The system of claim 43, further comprising the initiating end user selectively editing the restriction policy via the user interface.

56. The system of claim 43, wherein the restriction policy is configured by the initiating end user for each end user.

57. The system of claim 43, wherein an enforcement period of the restriction policy may be disabled by the initiating end user.

58. The system of claim 43, further comprising the initiating end user modifying the restriction policy relative to individual end users.

59. The system of claim 43, further comprising the initiating end user modifying the restriction policy relative to individual user devices.

60. The system of claim 43, wherein the initiating user receives reports on attempts to access the Internet during restricted times.

61. The system of claim 43, wherein at least a portion of the restriction policy is enforced by a DNS server.

62. The system of claim 43, wherein at least a portion of the restriction policy is resident on a DNS server.

63. A system for managing Internet access, the system comprising:
a user device having a user interface between an end user and a DNS server, the user interface configured for receiving a request to access the Internet by the end user;
the DNS server coupled to the user device and configured for determining whether the request is being made during a restricted time period, the restricted time period having been established by input of an initiating end user to a restriction policy application via a user interface between the initiating end user and the DNS server; and
a processor for executing the instructions stored in memory to:
selectively manage Internet access for the end user by blocking all Internet access if the determination is that the request was made during a restricted time period or granting Internet access if the determination is that the request was made outside the restricted time period.

64. The system of claim 63, wherein blocking the Internet access comprises redirecting a request to access an IP address specified in the request to a different IP address.

65. The system of claim 63, wherein blocking the Internet access further comprises displaying a message on the user device.

66. The system of claim 63, wherein the restricted time period includes morning, afternoon, evening, late night and any combination thereof.

67. The system of claim 63, wherein the restricted time period includes a start time and an end time.

68. The system of claim 63, wherein the restricted time period includes a day.

69. The system of claim 63, further comprising dynamically logging and reporting Internet access of the Internet content.

70. The system of claim 63, wherein the restricted time period is provided by a monitoring list generated by the DNS server or third parties.

71. The system of claim 63, wherein the restricted time period is provided by a monitoring list created by the initiating end user or socially produced by groups of users of the DNS server.

72. The system of claim 63, further comprising overriding the restriction policy application by the end user selecting an override button provided on the user interface.

73. The system of claim 63, further comprising modifying the restricted time period by the initiating end user selectively editing the restricted time period via the user interface.

74. The system of claim 63, further comprising the initiating end user selectively editing the restriction policy via the user interface.

75. The system of claim 63, wherein the restriction policy is configured by the initiating end user for each end user.

76. The system of claim 63, wherein an enforcement period of the restriction policy may be disabled by the initiating end user.

77. The system of claim 63, further comprising the initiating end user modifying the restriction policy relative to individual end users.

78. The system of claim 63, further comprising the initiating end user modifying the restriction policy relative to individual user devices.

79. The system of claim 63, wherein the initiating user receives reports on attempts to access the Internet during restricted times.

80. A non-transitory computer-readable storage medium having embodied thereon a program, the program executable by a processor in a computing device to perform a method for managing Internet access, the method comprising:
receiving a request to access the Internet by an end user via a user device coupled to an Internet service;
determining whether the request is being made during a restricted time period, the restricted time period having been established by input of an initiating end user to a restriction policy application via a user interface between the initiating end user and the Internet service; and
selectively managing Internet access for the end user by blocking all Internet access if the determination is that the request was made during a restricted time period or granting Internet access if the determination is that the request was made outside the restricted time period.
